(19) United States
(12) Patent Application Publication
(10) Pub. No.: US 2026/0229748 A1
(43) Pub. Date: Aug. 6, 2026

(54) LITHIUM-ION SECONDARY BATTERY

(71) Applicant: HONDA MOTOR CO., LTD., Tokyo (JP)

(72) Inventor: Toshiyuki ARIGA, Saitama (JP)

(21) Appl. No.: 19/530,353

(22) Filed: Feb. 5, 2026

(30) Foreign Application Priority Data
Feb. 6, 2025 (JP) 2025-018709

(51) Int. Cl. H01M 50/593; H01M 4/02; H01M 4/13; H01M 10/0525; H01M 10/42; H01M 50/586

(52) U.S. Cl. CPC H01M 50/593; H01M 4/13; H01M 10/0525; H01M 10/4235; H01M 50/586; H01M 2004/028; H01M 2200/00

(57) ABSTRACT

A lithium-ion secondary battery includes a stacked body in which a negative electrode including lithium and a positive electrode are stacked with an electrolyte therebetween. The positive electrode includes a positive-electrode current collector foil, a coating layer stacked on the positive-electrode current collector foil, and a positive-electrode active material layer stacked on the coating layer. An insulating member is disposed so as to cover a region in which the positive-electrode active material layer is not stacked on a surface of the coating layer facing the negative electrode in a stacking direction, and a region in which the coating layer is not stacked on a surface of the positive-electrode current collector foil facing the negative electrode in the stacking direction. The insulating member covers an end portion of the coating layer and is configured to prevent overlap with the positive-electrode active material layer in the stacking direction.

This application is based on and claims the benefit of priority from Japanese Patent Application No. 2025-018709, filed on 6 Feb. 2025, the content of which is incorporated herein by reference.

### BACKGROUND OF THE INVENTION

### Field of the Invention

The present invention relates to a lithium-ion secondary battery.

### Related Art

Conventionally, as for a lithium secondary battery, a technique is known in which a stacked body is configured with a negative electrode including lithium and a positive electrode including a positive-electrode current collector foil and a positive-electrode composite layer. An example of a document disclosing such a technique is PCT International Publication No. WO2024/071255.

PCT International Publication No. WO2024/071255 relates to a non-aqueous electrolyte secondary battery including a positive electrode, a negative electrode, and a non-aqueous electrolytic solution. The positive electrode includes a current collector, an undercoat layer covering a surface of the current collector, and a positive-electrode composite layer provided on the undercoat layer.

Patent Document 1: PCT International Publication No. WO2024/071255

### SUMMARY OF THE INVENTION

Heat generation during battery use may cause a malfunction during battery use. For example, in a lithium secondary battery in which a separator is disposed between a positive electrode and a negative electrode, when the temperature rises to approximately 150° C., thermal shrinkage of the separator occurs, and short-circuiting may occur between the positive electrode and the negative electrode due to breakage or deformation of the separator. When the temperature in the vicinity of the positive-electrode current collector foil reaches approximately 180° C., molten lithium flows from the negative electrode, comes into contact with the positive-electrode current collector foil, and a low-resistance short circuit may occur.

By disposing an insulating member, it is possible to prevent short-circuiting caused by breakage of the separator at high temperature or impacts from outside. However, when the insulating member is disposed in a range from the positive-electrode current collector foil to the positive-electrode active material layer so as not to expose the positive-electrode current collector foil, thickness of a portion of the insulating member that covers the positive-electrode active material layer forms a step, causing non-uniform constraint force and possibly resulting in non-uniform deposition of lithium. Although a method may be adopted in which the insulating member is disposed apart from the positive-electrode active material layer so that no step occurs, a gap is formed between the positive-electrode active material layer and the insulating member, and the positive-electrode current collector foil may be exposed, causing a short circuit.

An object of the present invention is to provide a lithium-ion secondary battery capable of effectively preventing short-circuiting of the positive-electrode current collector foil while suppressing non-uniform deposition of lithium.

(1) A lithium-ion secondary battery (for example, a lithium-ion secondary battery 1 or 1a described later) includes a stacked body (for example, a stacked body 10 described later) in which a negative electrode including lithium (for example, a negative electrode 20 described later) and a positive electrode (for example, a positive electrode 40 described later) are stacked with an electrolyte (for example, an electrolyte 30 described later) therebetween. The positive electrode includes a positive-electrode current collector foil (for example, a positive-electrode current collector foil 41 described later), a coating layer (for example, a coating layer 42 described later) stacked on the positive-electrode current collector foil, and a positive-electrode active material layer (for example, a positive-electrode active material layer 43 described later) stacked on the coating layer. An insulating member (for example, an insulating member 60 or 160 described later) is disposed so as to cover a region (for example, a region 421 described later) in which the positive-electrode active material layer is not stacked on a surface of the coating layer that faces the negative electrode in a stacking direction, and a region (for example, a region 411 described later) in which the coating layer is not stacked on a surface of the positive-electrode current collector foil that faces the negative electrode in the stacking direction. The insulating member covers an end portion of the coating layer and is configured to prevent overlap with the positive-electrode active material layer in the stacking direction.

(2) The lithium-ion secondary battery as described in the item (1), in which a volume resistivity of the insulating member is 1×10¹⁵ Ω·cm or more.

(3) The lithium-ion secondary battery as described in item (1) or (2), in which the volume resistivity of the insulating member is 1×10²⁰ Ω·cm or less.

(4) The lithium-ion secondary battery as described in any one of items (1) to (3), in which a thickness of the insulating member is between 5 μm and 100 μm inclusive.

(5) The lithium-ion secondary battery as described in any one of items (1) to (4), in which a melting point of the insulating member is 180° C. or more.

(6) The lithium-ion secondary battery as described in any one of items (1) to (5), further including a separator (for example, a separator 50 described later) disposed between the negative electrode and the positive electrode.

(7) The lithium-ion secondary battery as described in item (6), in which the insulating member is configured to fill a space between the positive electrode and the separator in the stacking direction.

(8) The lithium-ion secondary battery as described in to item (7), in which the insulating member has thermal fusibility.

(9) The lithium-ion secondary battery as described in item (8), in which the insulating member includes an adhesive layer (for example, an adhesive layer 161 described later) having adhesiveness on a surface facing the positive-electrode current collector foil and the coating layer, and a heat-melting layer (for example, a heat-melting layer 162 described later) disposed on the separator side with respect to the adhesive layer and having thermal fusibility.

According to the present invention, it is possible to provide a lithium-ion secondary battery capable of effectively preventing short-circuiting of the positive-electrode current collector foil while suppressing non-uniform deposition of lithium.

### BRIEF DESCRIPTION OF THE DRAWINGS

FIG. 1 is a conceptual cross-sectional view illustrating a configuration of a lithium-ion secondary battery according to an embodiment of the present invention;

FIG. 2 is a schematic view illustrating a positional relationship between a positive electrode and an insulating member in the lithium-ion secondary battery of the present embodiment, as viewed in a direction perpendicular to a stacking direction;

FIG. 3 is a schematic view illustrating the positional relationship between the positive electrode and the insulating member in the lithium-ion secondary battery of the present embodiment, as viewed in the stacking direction;

FIG. 4 is a schematic view illustrating a positional relationship between a positive electrode and an insulating member in a lithium-ion secondary battery of a first comparative example, as viewed in a direction perpendicular to the stacking direction;

FIG. 5 is a schematic view illustrating a positional relationship between a positive electrode and an insulating member in a lithium-ion secondary battery of a second comparative example, as viewed in a direction perpendicular to the stacking direction;

FIG. 6 is a conceptual cross-sectional view illustrating a configuration of a lithium-ion secondary battery of a modified example; and

FIG. 7 is a schematic view illustrating a positional relationship between a positive electrode and an insulating member in the lithium-ion secondary battery of the modified example, as viewed in a direction perpendicular to the stacking direction.

### DETAILED DESCRIPTION OF THE INVENTION

Hereinafter, an embodiment of the present invention will be described in detail with reference to the drawings.

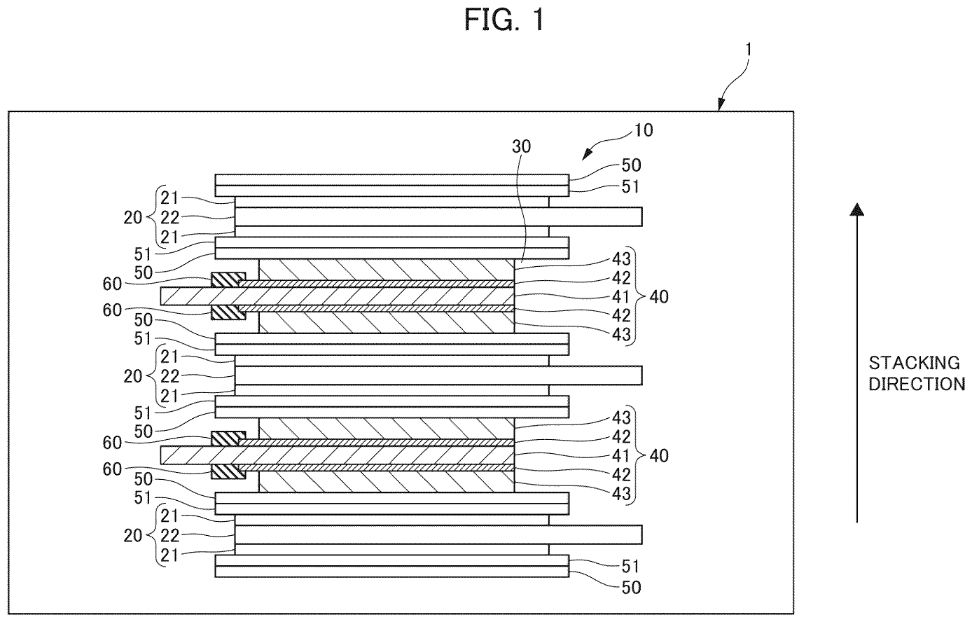

FIG. 1 is a conceptual cross-sectional view illustrating a configuration of a lithium-ion secondary battery 1 according to an embodiment of the present invention. The lithium-ion secondary battery 1 of the present embodiment includes a plurality of stacked bodies 10. The stacked body 10 includes a negative electrode 20, an electrolyte 30, a positive electrode 40, a separator 50, and an insulating member 60. In the following description, a direction in which respective components of the stacked body 10 are stacked is referred to as a stacking direction.

A positional relationship among the respective components of the stacked body 10 will be described. The positional relationship among the components constituting the stacked body 10 is such that the negative electrode 20, the electrolyte 30, and the positive electrode 40 are arranged in this order in the stacking direction. The separator 50 is disposed between the negative electrode 20 and the positive electrode 40. In the example illustrated in FIG. 1, the separator 50, the negative electrode 20, the separator 50, the positive electrode 40, the separator 50, the negative electrode 20, the separator 50, and the positive electrode 40 are arranged in this order in the stacking direction. The insulating member 60 is positioned between the separators 50.

The negative electrode 20 includes lithium. The negative electrode 20 includes a negative-electrode active material layer 21 and a negative-electrode current collector layer 22. The negative-electrode active material layer 21 is formed on each of both surfaces of the negative-electrode current collector layer 22, the surfaces facing in the stacking direction. In the stacking direction, the entire surface of the negative-electrode active material layer 21 on a side opposite to the negative-electrode current collector layer 22 faces a conductive layer 51 of the separator 50 described later.

The negative-electrode active material layer 21 is not particularly limited and is formed from known negative-electrode active materials used for negative-electrode active material layers. From the viewpoint of improving the energy density of the lithium-ion secondary battery 1, it is preferable that the negative-electrode active material layer 21 be a lithium metal layer in which the negative-electrode active material is lithium metal. The lithium metal includes lithium alloys, in addition to lithium metal itself. The negative-electrode active material layer 21 may alternatively be formed from silicon-based active materials such as Si and Si alloys, lithium transition-metal oxides such as lithium titanium oxide (Li₄Ti₅O₁₂), transition-metal oxides such as TiO₂, Nb₂O₃, and WO₃, metal sulfides, metal nitrides, carbon materials such as graphite, soft carbon, and hard carbon, and metal indium.

The negative-electrode current collector layer 22 is not particularly limited and may be formed from copper, nickel, or stainless steel. Examples of shapes of the negative-electrode current collector layer 22 include foil, plate, mesh, non-woven fabric, and foam.

The electrolyte 30 is a source of lithium ions, which are charge transfer media, and includes a lithium salt. Examples of lithium salts include LiPF₆, LiBF₄, LiClO₄, LiAsF₆, LiCF₃SO₃, LiC(CF₃SO₂)₃, LiN(CF₃SO₂)₂ (LiTFSI), LiN(FSO₂)₂ (LiFSI), and LiBC₄O₈. A single lithium salt may be used alone, or two or more lithium salts may be used in combination.

The electrolyte 30 exists as an electrolytic solution containing an organic solvent. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. A single organic solvent may be used alone, or two or more organic solvents may be used in combination.

A solid electrolyte may also be used as the electrolyte 30. In this case, the electrolyte 30 is stacked between the positive electrode 40 and the negative electrode 20. As the solid electrolyte, any material having lithium-ion conductivity may be used without particular limitation, and examples thereof include oxide electrolytes and sulfide electrolytes.

The positive electrode 40 includes a positive-electrode current collector foil 41, a coating layer 42, and a positive-electrode active material layer 43. The positive-electrode current collector foil 41, the coating layer 42, and the positive-electrode active material layer 43 are arranged in this order (the positive-electrode current collector foil 41, the coating layer 42, and the positive-electrode active material layer 43) in the stacking direction.

A material for the positive-electrode current collector foil 41 is not particularly limited and is formed from known current-collecting materials used for positive-electrode current collectors in lithium secondary batteries. For example, the positive-electrode current collector foil 41 may be formed from a known composite current-collector foil including a metal such as aluminum and a resin layer such as polyethylene, polypropylene, or polyethylene terephthalate. The positive-electrode current collector foil 41 is not limited to a composite current-collector foil and may be a single metal foil such as an aluminum foil.

The coating layer 42 is stacked on the positive-electrode current collector foil 41. In the present embodiment, the coating layer 42 is formed on each of both surfaces of the positive-electrode current collector foil 41, the surfaces facing in the stacking direction.

The coating layer 42 is configured such that its coated area is larger than an area of the positive-electrode current collector foil 41 that overlaps the positive-electrode active material layer 43 in the stacking direction. It may also be said that an area of the coating layer 42 on a surface facing in the stacking direction is larger than an area of the positive-electrode active material layer 43 on a surface facing in the stacking direction. Alternatively, a length of the coating layer 42 may be longer than a length of the positive-electrode active material layer 43.

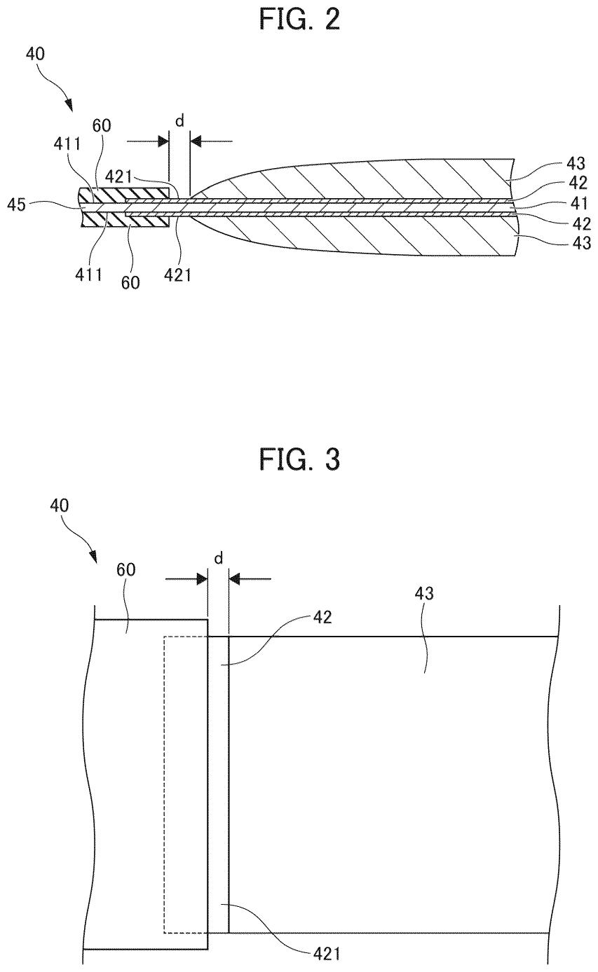

Here, as illustrated in FIG. 2 and FIG. 3 described later, when a distance d between an end portion of the insulating member 60 and an end portion of the positive-electrode active material layer 43 is greater than 0, the coating layer 42 is exposed, as viewed in the stacking direction. From the viewpoints of energy density and low-resistance short-circuiting, it is preferable that a width dimension of the exposed portion of the coating layer 42, that is, the distance d, be small. Specifically, it is preferable that the distance d be smaller than one-half of a protrusion width of the negative-electrode active material layer 21, which protrudes outward beyond the positive-electrode active material layer 43.

A material for the coating layer 42 is not particularly limited. From the viewpoint of effectively preventing short-circuiting of the positive-electrode current collector foil 41, it is preferable that the coating layer 42 be formed from a known coating material used as a PTC (Positive Temperature Coefficient) coating layer having a function of increasing resistance and limiting current when an abnormal large current flows. For example, the coating layer 42 may be formed from a mixture of ceramics or an expanding agent with a conductive material.

From the viewpoint of effectively preventing short-circuiting of the positive-electrode current collector foil 41, it is preferable that the resistance value of the coating layer 42 be between one-tenth and ten times inclusive the surface resistance of the positive electrode 40, and be ten times or more the resistance of the positive-electrode current collector foil 41. Further, it is more preferable that the coating layer 42 be made of a material having a property in which ceramics or an expanding agent expands during heat generation and resistance increases.

The coating layer 42 is not limited to a PTC coating layer, and may be an adhesive layer for adhering the positive-electrode active material layer 43 or another component to the positive-electrode current collector foil 41.

The positive-electrode active material layer 43 is formed on the coating layer 42. In the present embodiment, the surface of the positive-electrode active material layer 43 opposite to the surface facing the coating layer 42 in the stacking direction faces the separator 50.

The positive-electrode active material layer 43 includes a positive-electrode active material, and may further include a conductive additive, a binder, and the like. The positive-electrode active material is not particularly limited as long as being capable of intercalating and releasing lithium ions, and examples thereof include lithium nickel cobalt manganese composite oxides. As the solid electrolyte, any material having lithium-ion conductivity may be used without particular limitation, and examples thereof include oxide electrolytes and sulfide electrolytes. The conductive additive is not particularly limited as long as having electronic conductivity, and examples thereof include carbon black. The binder is not particularly limited as long as being capable of improving binding properties, and examples thereof include styrene-butadiene rubber.

A material for the separator 50 is not particularly limited, and examples thereof include porous sheets and non-woven fabric sheets. Examples of materials for the porous sheet include polyolefins such as polyethylene and polypropylene, aramid, polyimide, and fluorocarbon resins. Examples of materials for the non-woven fabric sheet include glass fiber and cellulose fiber.

The separator 50 may include a conductive layer 51. The conductive layer 51 is stacked on the separator 50. The conductive layer 51 is formed on a surface of the separator 50 opposite to a side facing the positive-electrode active material layer 43, that is, on a side facing the negative electrode 20. A material for the conductive layer 51 is not particularly limited, and examples thereof include carbon materials such as carbon black and carbon nanotubes, and materials containing metals such as copper.

Next, the insulating member 60 will be described. First, with reference to FIG. 2 and FIG. 3, a positional relationship of the insulating member 60 will be described. FIG. 2 is a schematic view illustrating a positional relationship between the positive electrode 40 and the insulating member 60 in the lithium-ion secondary battery 1 of the present embodiment, as viewed in a direction perpendicular to the stacking direction. FIG. 3 is a schematic view illustrating the positional relationship between the positive electrode 40 and the insulating member 60 in the lithium-ion secondary battery 1 of the present embodiment, as viewed in the stacking direction. In FIG. 2, since the positive electrode 40 is illustrated in a shape similar to the actual shape, the end portion of the positive-electrode active material layer 43 is illustrated as a gentle curved surface; however, the positive electrode 40 in FIG. 2 is to be regarded as the same one illustrated in FIG. 1.

As illustrated in FIG. 2 and FIG. 3, the coating layer 42 is formed on the positive-electrode current collector foil 41. However, at an end portion of the positive electrode 40, there exists a region 411 in which the coating layer 42 is not formed. In this example, the region 411 in which the coating layer 42 is not formed is provided near a current-collector tab portion 45. The positive-electrode active material layer 43 is formed on the coating layer 42; however, a region 421 in which the positive-electrode active material layer 43 is not formed exists at an end portion of the coating layer 42.

The insulating member 60 is disposed in the region 421 in which the positive-electrode active material layer 43 is not formed on the coating layer 42. That is, as viewed in the stacking direction, the insulating member 60 does not overlap the positive-electrode active material layer 43 and is disposed in a portion of the coating layer 42 that is exposed externally.

A distance d between an end portion of the insulating member 60 and an end portion of the positive-electrode active material layer 43 is 0 or greater. This also includes a case in which the distance d is 0, that is, an end portion of the insulating member 60 and an end portion of the positive-electrode active material layer 43 are in point contact. In this manner, the insulating member 60 only needs to be configured to cover an end portion of the coating layer 42 and configured to prevent overlap with the positive-electrode active material layer 43 in the stacking direction. This makes it possible to effectively prevent short-circuiting of the positive-electrode current collector foil 41 while suppressing non-uniform deposition of lithium.

When the distance d is greater than 0, a portion of the coating layer 42 is exposed, as viewed in the stacking direction. From the viewpoints of energy density and low-resistance short-circuiting, it is preferable that a width dimension of the exposed portion of the coating layer 42, that is, the distance d, be small. Specifically, it is preferable that the distance d be smaller than one-half of a protrusion width of the negative-electrode active material layer 21, which protrudes outward beyond the positive-electrode active material layer 43.

Further, a portion of the insulating member 60 located on a side opposite to the positive-electrode active material layer 43 in a longitudinal direction of the positive-electrode current collector foil 41 covers part of the region 411 in which the coating layer 42 is not formed. That is, the insulating member 60 is disposed so as to extend across the region 421 on the coating layer 42 and the region 411 on the positive-electrode current collector foil 41.

Physical properties of the insulating member 60 will be described. The insulating member 60 is formed in a thin-film tape shape. From the viewpoints of suppressing non-uniform deposition of lithium and preventing short-circuiting of the positive-electrode current collector foil, it is preferable that a thickness of the insulating member 60 be between 5 μm and 100 μm inclusive, more preferably between 5 μm and 50 μm inclusive, and particularly preferably between 5 μm and 30 μm inclusive. A thickness of the insulating member 60 may also be defined based on a thickness of the positive-electrode active material layer 43. For example, it is preferable that the thickness of the insulating member 60 be equal to or less than the thickness of the positive-electrode active material layer 43.

From the viewpoints of insulation and heat resistance, it is preferable that the insulating member 60 have a volume resistivity of 1×10¹⁵ Ω·cm or more and a melting point of 180° C. or more.

The insulating member 60 is formed from a resin film having thermal fusibility. Examples of the resin include known resins such as polypropylene, polyethylene terephthalate, and polyimide. From the viewpoint of heat resistance, polyimide is preferable. The insulating member 60 has an adhesive surface and is adhered to the positive-electrode current collector foil 41. A Kapton® tape may be used as the insulating member 60.

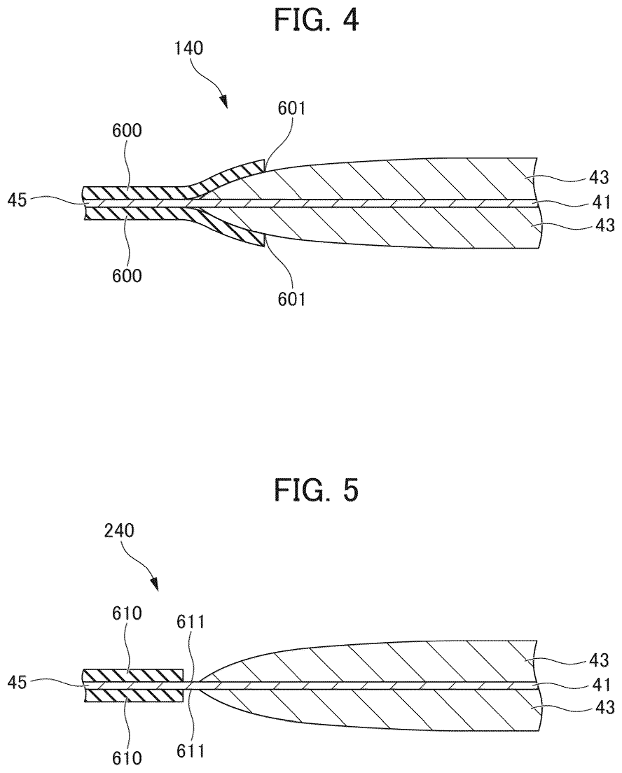

Next, comparative examples will be described with reference to FIG. 4 and FIG. 5 to explain effects of the lithium-ion secondary battery 1 of the present embodiment. Components common or similar to those of the above embodiment are denoted by the same reference numerals, and detailed description thereof is omitted.

FIG. 4 is a schematic view illustrating a positional relationship between a positive electrode 140 and an insulating member 600 in a lithium-ion secondary battery of a first comparative example, as viewed in a direction perpendicular to the stacking direction. As illustrated in FIG. 4, the positive electrode 140 of the first comparative example includes the positive-electrode current collector foil 41 and a positive-electrode active material layer 43 stacked on the positive-electrode current collector foil 41. Unlike the lithium-ion secondary battery 1 of the above embodiment, no coating layer 42 is provided. The positive-electrode active material layer 43 is formed on both surfaces of the positive-electrode current collector foil 41 in the stacking direction.

The insulating member 600 of the first comparative example is adhered to an area from the positive-electrode current collector foil 41 to an end portion of the positive-electrode active material layer 43. The insulating member 600 of the first comparative example is disposed on both sides of the positive-electrode current collector foil 41 and thus sandwiches the positive electrode 140 in the stacking direction. Accordingly, when the separator 50 having the conductive layer 51 is bent, it is possible to avoid a situation in which an end surface of the conductive layer 51 short-circuits the positive-electrode current collector foil 41, or a situation in which positional deviation of the conductive layer 51 due to tolerances causes short-circuiting with the positive-electrode current collector foil 41 that has been bent for a lead-tab connection.

However, in the first comparative example, a step occurs at an end portion 601 of the insulating member 600 due to its thickness. Since the positive electrode 140 is constrained in the stacking direction by components (not illustrated) such as the separator 50, an equal pressure is not applied at the stepped portion. As a result of the pressure becoming non-uniform, deposition of lithium becomes concentrated in the stepped portion, leading to a non-uniform deposition reaction and a reduction in battery life. Near a root side of the current-collector tab portion 45, there are cases in which a coated portion of the positive-electrode active material layer 43 stacked on the positive-electrode current collector foil 41 is formed so as to protrude toward the end portion, and the restraining pressure on the protruding coated portion tends to become non-uniform. In the configuration of the first comparative example, there is a problem that non-uniform deposition of lithium is likely to occur.

In the first comparative example and the embodiment, charge-discharge tests were conducted on battery cells. In the first comparative example, an initial charge-discharge efficiency tended to deteriorate at a higher probability, and yield decreased by approximately 20% compared with the embodiment. It is presumed that yield deterioration due to initial-stage charge-discharge efficiency results from non-uniform deposition of lithium.

FIG. 5 is a schematic view illustrating a positional relationship between a positive electrode 240 and an insulating member 610 in a lithium-ion secondary battery of a second comparative example, as viewed in a direction perpendicular to the stacking direction. As illustrated in FIG. 5, the positive electrode 240 of the second comparative example also includes the positive-electrode current collector foil 41 and a positive-electrode active material layer 43 stacked on the positive-electrode current collector foil 41, and does not include the coating layer 42.

The insulating member 610 of the second comparative example is disposed at a position spaced apart from the positive-electrode active material layer 43 in order to avoid the step formation that occurred in the first comparative example. Accordingly, an exposed portion 611 in which the positive-electrode current collector foil 41 is exposed externally is formed between the insulating member 610 and the positive-electrode active material layer 43. If an external impact is applied or the separator 50 is damaged due to the presence of foreign matter, the exposed portion 611 of the positive-electrode current collector foil 41 may come into contact with the negative electrode 20, and a low-resistance short circuit may occur. In the configuration of the second comparative example, the possibility of short-circuit occurrence becomes higher than in the first comparative example.

In this regard, the lithium-ion secondary battery 1 of the present embodiment is configured as follows. That is, the lithium-ion secondary battery 1 includes the stacked body 10 in which the negative electrode 20 including lithium and the positive electrode 40 are stacked with the electrolyte 30 therebetween. The positive electrode 40 includes the positive-electrode current collector foil 41, the coating layer 42 stacked on the positive-electrode current collector foil 41, and the positive-electrode active material layer 43 stacked on the coating layer 42. The insulating member 60 is disposed so as to cover the region 421 in which the positive-electrode active material layer 43 is not stacked on a surface of the coating layer 42 facing the negative electrode 20 in the stacking direction, and the region 411 in which the coating layer 42 is not stacked on a surface of the positive-electrode current collector foil 41 facing the negative electrode 20 in the stacking direction. The insulating member 60 covers an end portion of the coating layer 42 and is configured to prevent overlap with the positive-electrode active material layer 43 in the stacking direction.

Accordingly, since the insulating member 60 is disposed with a spacing from the positive-electrode current collector foil 41, non-uniform lithium deposition as observed in the first comparative example can be prevented. A portion of the positive-electrode current collector foil 41 of the positive electrode 40, on which the positive-electrode active material layer 43 is not stacked, is covered with the coating layer 42 and the insulating member 60, and the positive-electrode current collector foil 41 is not exposed. Therefore, even if thermal shrinkage of the separator 50 occurs due to abnormal heat generation, short-circuiting between the exposed portion of the positive-electrode current collector foil 41 and the negative electrode 20, as in the second comparative example, can be prevented. That is, both functions of preventing non-uniform deposition of lithium and preventing short-circuiting can be achieved simultaneously.

A volume resistivity of the insulating member 60 of the present embodiment may be 1×10¹⁵ Ω·cm or more. This allows the insulating member 60 to appropriately exhibit the insulating function. An upper limit of the volume resistivity of the insulating member 60 of the present embodiment is not particularly limited, but may be 1×10²⁰ Ω·cm or less.

A thickness of the insulating member 60 of the present embodiment is between 5 μm and 100 μm inclusive. Accordingly, a lithium secondary battery having a good insulating function can be achieved without adversely affecting a restraining force due to the thickness of the insulating member 60.

A melting point of the insulating member 60 of the present embodiment is 180° C. or more. When a temperature in the vicinity of the positive-electrode current collector foil 41 becomes high, molten lithium flowing from the negative electrode may contact the positive-electrode current collector foil 41, causing a low-resistance short circuit and potentially resulting in loss of battery function. In this regard, in the configuration of the present embodiment, since the melting point of the insulating member 60 is 180° C. or more, it is possible to avoid a situation in which the insulating member 60 melts before a low-resistance short circuit occurs, thereby the allowing the insulating member 60 to prevent short-circuit more reliably.

The lithium-ion secondary battery 1 of the present embodiment further includes the separator 50 disposed between the negative electrode 20 and the positive electrode 40. Accordingly, by using the separator 50 together with the insulating member 60, short-circuiting due to contact between the positive electrode 40 and the negative electrode 20 can be more reliably prevented.

Next, a modified example of the lithium-ion secondary battery 1 of the present embodiment will be described. In the following description, components common or similar to those described in the above embodiment are denoted by the same reference numerals, and detailed description thereof may be omitted.

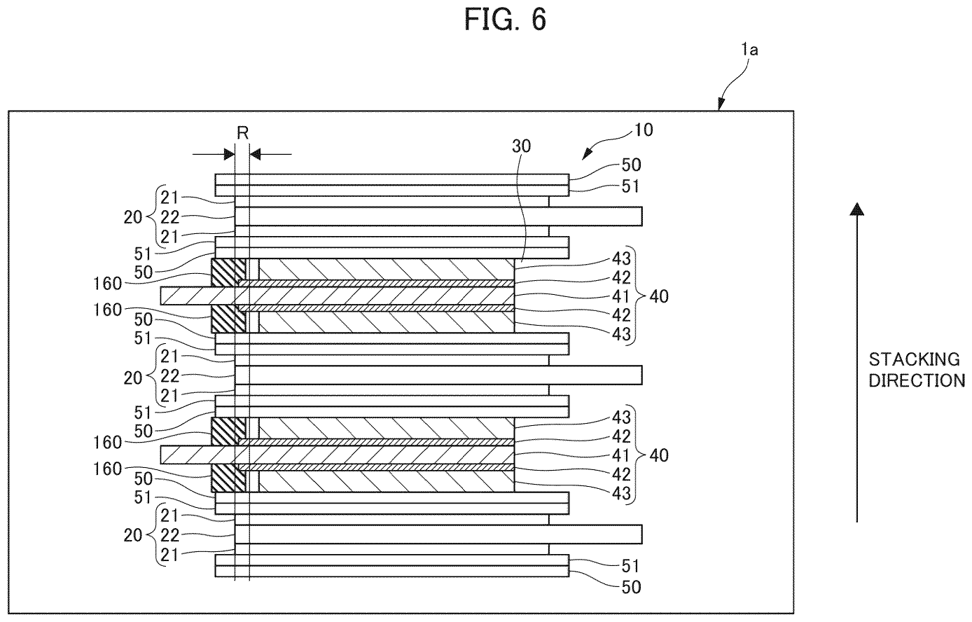

FIG. 6 is a conceptual cross-sectional view illustrating a configuration of a lithium-ion secondary battery 1a of a modified example. In the lithium-ion secondary battery 1a of the modified example, a configuration of an insulating member 160 differs from that in the above embodiment. Components of the lithium-ion secondary battery 1a other than the insulating member 160 are regarded as being common to those of the above embodiment.

As illustrated in FIG. 6, the insulating member 160 of the modified example is formed with a thickness that fills a space between the positive-electrode current collector foil 41 and the separator 50 in the stacking direction.

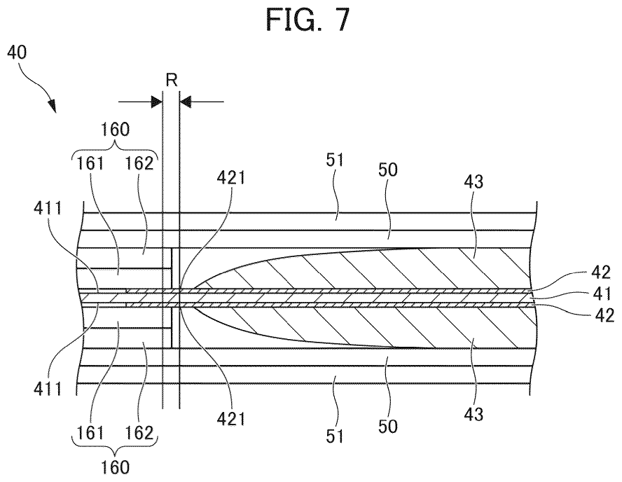

FIG. 7 is a schematic view illustrating a positional relationship between the positive electrode 40 and the insulating member 160 in the lithium-ion secondary battery 1a of the modified example, as viewed in a direction perpendicular to the stacking direction. As illustrated in FIG. 7, the insulating member 160 includes an adhesive layer 161 and a heat-melting layer 162.

The adhesive layer 161 is a layer on a side facing the region 411 of the positive-electrode current collector foil 41 and the region 421 of the coating layer 42, and includes an adhesive surface. The insulating member 160 is fixed by the adhesive layer 161.

The heat-melting layer 162 is a layer on a side facing the separator 50 and is formed from a material capable of being melt-adhered to the separator 50. By heat-pressing a region R illustrated in FIG. 7, the heat-melting layer 162 melts and bonds to the separator 50.

As described above, in the lithium-ion secondary battery 1a of the modified example, the insulating member 160 is configured to fill a space between the positive electrode 40 and the separator 50 in the stacking direction. Accordingly, even if the restraining pressure of the stacked body 10 becomes unstable due to stacking misalignment or the like and low-density (porous) lithium is deposited and tends to fall off, the insulating member 160 filling the space between the positive electrode 40 and the separator 50 in the stacking direction can prevent short-circuiting.

The insulating member 160 of the modified example has thermal fusibility. Accordingly, the insulating member 160 can be fixed to the stacked body 10 by thermal fusion bonding through heating such as heat pressing.

The insulating member 160 of the modified example includes the adhesive layer 161 having adhesiveness on a surface facing the positive-electrode current collector foil 41 and the coating layer 42, and the heat-melting layer 162 disposed on the separator 50 side with respect to the adhesive layer 161 and having thermal fusibility. Accordingly, heat pressing can be performed while the insulating member 160 is fixed to the positive-electrode current collector foil 41 and the coating layer 42 by the adhesive layer 161. Since one surface of the insulating member 160 in the stacking direction is fixed, a process of melt-adhering the insulating member 160 to the separator 50 can be performed stably.

The lithium-ion secondary battery 1a may have a configuration in which another insulating member 160 similar to the insulating member 160 is further included not only between the positive electrode 40 and the separator 50 but also on the negative electrode 20 side.

Although the embodiment of the present invention has been described above, the present invention is not limited to the above embodiment and may be modified as appropriate within the scope of the spirit of the present invention. For example, in the above embodiment, the coating layer 42 and the positive-electrode active material layer 43 are formed on both surfaces of the positive-electrode current collector foil 41; however, this configuration is not limiting. A configuration may be adopted in which the coating layer 42 and the positive-electrode active material layer 43 are formed only on one surface of the positive-electrode current collector foil 41.

### EXPLANATION OF REFERENCE NUMERALS

1, 1a: lithium-ion secondary battery
10: stacked body
20: negative electrode
30: electrolyte
40: positive electrode
41: positive-electrode current collector foil
411: region
42: coating layer
421: region
43: positive-electrode active material layer
60, 160: insulating member
161: adhesive layer
162: heat-melting layer

What is claimed is:

1. A lithium-ion secondary battery, comprising:
a stacked body in which a negative electrode including lithium and a positive electrode are stacked with an electrolyte therebetween,
wherein the positive electrode includes a positive-electrode current collector foil, a coating layer stacked on the positive-electrode current collector foil, and a positive-electrode active material layer stacked on the coating layer,
an insulating member is disposed so as to cover a region in which the positive-electrode active material layer is not stacked on a surface of the coating layer facing the negative electrode in a stacking direction and a region in which the coating layer is not stacked on a surface of the positive-electrode current collector foil facing the negative electrode in the stacking direction, and
the insulating member is configured to cover an end portion of the coating layer and to prevent overlap with the positive-electrode active material layer in the stacking direction.

2. The lithium-ion secondary battery according to claim 1, wherein a volume resistivity of the insulating member is 1×10¹⁵ Ω·cm or more.

3. The lithium-ion secondary battery according to claim 1, wherein a volume resistivity of the insulating member is 1×10²⁰ Ω·cm or less.

4. The lithium-ion secondary battery according to claim 1, wherein a thickness of the insulating member is between 5 μm and 100 μm inclusive.

5. The lithium-ion secondary battery according to claim 1, wherein a melting point of the insulating member is 180°C or more.

6. The lithium-ion secondary battery according to claim 1, further comprising a separator disposed between the negative electrode and the positive electrode.

7. The lithium-ion secondary battery according to claim 6, wherein the insulating member is configured to fill a space between the positive electrode and the separator in the stacking direction.

8. The lithium-ion secondary battery according to claim 7, wherein the insulating member has thermal fusibility.

9. The lithium-ion secondary battery according to claim 8, wherein the insulating member includes:
an adhesive layer having adhesiveness on a surface facing the positive-electrode current collector foil and the coating layer; and
a heat-melting layer disposed on a side of the separator with respect to the adhesive layer and having thermal fusibility.
